(19) United States
(12) Patent Application Publication
(10) Pub. No.: US 2016/0191858 A1
(43) Pub. Date: Jun. 30, 2016

(54) METHOD AND SYSTEM FOR MEASURING LATENCIES IN IP CAMERAS

(71) Applicant: MOTOROLA SOLUTIONS, INC, SCHAUMBURG, IL (US)

(72) Inventors: TYRONE D. BEKIARES, PARK RIDGE, IL (US); IRINA KLEYMAN, WHEELING, IL (US); HINRICH A. SCHMIDT, ALGONQUIN, IL (US)

(21) Appl. No.: 14/584,812

(22) Filed: Dec. 29, 2014

(51) Int. Cl. H04N 7/18; H04L 12/26; H04N 5/232

(52) U.S. Cl. CPC H04N 7/183; H04N 5/23206; H04L 43/0852

(57) ABSTRACT

A method and system enable determining one or more delays associated with an internet protocol (IP) camera. The method includes issuing a control command from a device to the IP camera. A change is then detected in one or more pixels in video frames as a result of the control command being executed by the IP camera. One or more delays associated with the IP camera are then determined by recording and comparing two or more of the following: a command time; a feedback time; and a capture time.

### BACKGROUND OF THE INVENTION

Internet Protocol (IP) cameras are commonly used in video surveillance applications to transmit video from a remote camera location to a centralized recording system or viewing terminal via an IP communications network.

Recently, some municipalities have constructed large scale video surveillance networks comprising thousands to tens-of-thousands of networked IP cameras. These IP cameras may be connected back to a central office using a myriad of backhaul technologies, inclusive of wired, point-to-point wireless, and public wireless technologies.

In such surveillance networks, it is imperative to be able to quantify camera and network performance For example, quantitative rubrics provide a framework by which a service provider and customer can agree on successful installation and operation of a given camera.

Latency or delay is one such characteristic that impacts camera performance For cameras whose Pan, Tilt, and Zoom (PTZ) controls are remotely operable, it is imperative that latency be kept low and relatively static. For PTZ and fixed cameras, it can also be important to understand the end-to-end latency if the camera is being used for tactical operations.

Different backhaul technologies are associated with different latency characteristics, some of which may be subject to impact from semi-static changes to the system architecture (e.g., added cameras sharing the same backhaul), or dynamic changes to throughput availability (e.g., a peak in consumer traffic on a public wireless network). Because latency can change over the short and long term (dependent on the backhaul technology), latency generally should be validated and revalidated with some frequency.

However, effective measurement of IP camera latency faces a number of challenges. When latency is measured from a single remote endpoint, it is difficult to directly measure one-way latencies and/or to determine specific latencies associated with encoding, processing, and mechanical PTZ motor movements.

Further, measuring latency in a scalable fashion in large scale video surveillance networks requires an ability to measure camera latency while “in service” without disabling each camera's operation or physically adapting the camera.

Accordingly, there is a need for a method and system for measuring latencies in IP cameras.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system in accordance with some embodiments.

FIG. 2 is a flowchart of a method of determining one or more delays associated with an IP camera in accordance with some embodiments.

FIG. 3 is a schematic illustrating one or more delays in accordance with some embodiments.

FIG. 4 is a schematic illustrating processing steps in a device and an IP camera and one or more delays in accordance with some embodiments.

FIG. 5 is a schematic showing an example determination of one or more latency times in accordance with some embodiments.

FIG. 6 is a block diagram of a device for determining one or more delays associated with an IP camera in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

A method of determining one or more delays associated with an internet protocol (IP) camera is described herein. According to one embodiment, the method comprises the following steps: A control command is issued from a device to an IP camera. In a streaming video being received at the device from the IP camera, a change is detected in one or more pixels in the video frames as a result of the control command being executed by the IP camera. One or more delays associated with the IP camera are determined by recording and comparing two or more of the following: a command time, a capture time, and a feedback time.

The command time is a time at which the control command was issued from the device. The capture time is a time at which the change in one or more pixels in the video frames as a result of the control command being executed by the IP camera was captured by the IP camera. The feedback time is a time at which the change in one or more pixels in the video frames as a result of the control command being executed by the IP camera was detected at the device.

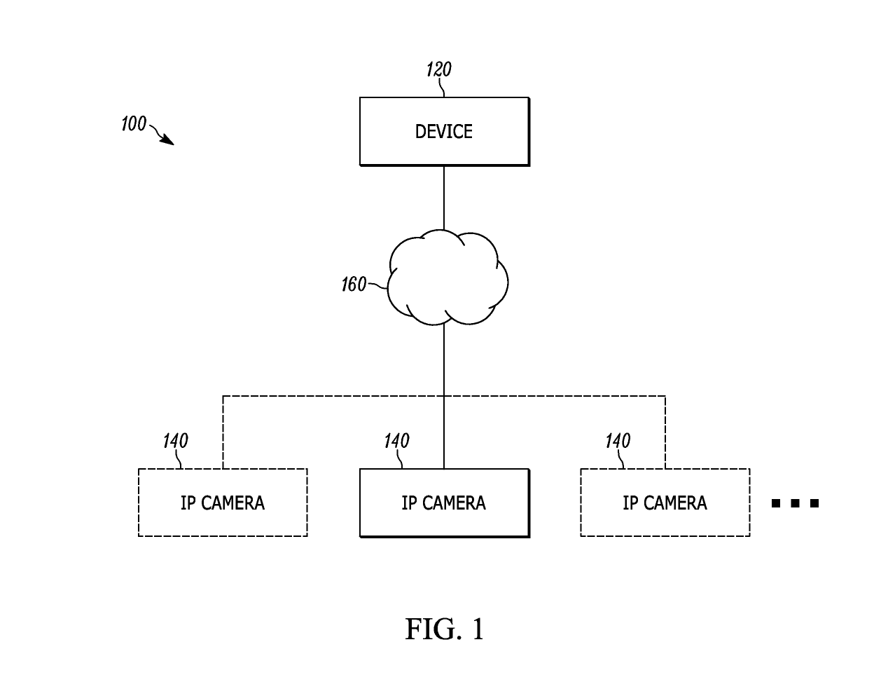

FIG. 1 is a block diagram of a system 100 in accordance with some embodiments. The system comprises a device 120 coupled via a communications network 160 to one or more IP cameras 140. The device 120 is used to determine one or more delays associated with the one or more IP cameras 140.

In some embodiments, the one or more IP cameras 140 are surveillance cameras and the communications network 160 enables the device 120 to communicate with the IP cameras 140, for example, to receive streaming video from the one or more IP cameras 140 and to transmit control commands to the one or more IP cameras 140. The communications network 160 can comprise, for example, the Internet and/or any other private or public wired or wireless communications networks that support communication with the IP cameras 140.

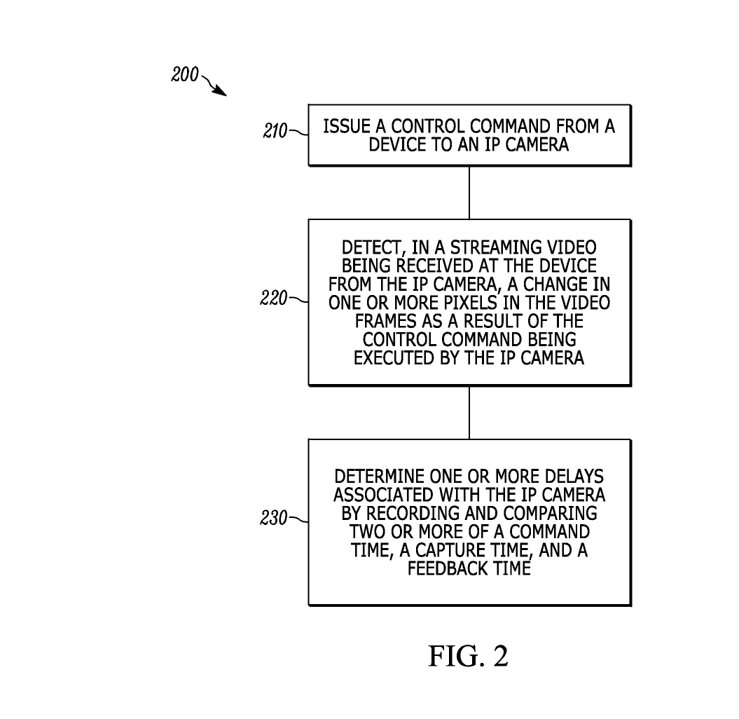

FIG. 2 is a flowchart of a method 200 of determining one or more delays associated with an IP camera in accordance with some embodiments. The method 200 can be implemented, for example, in the system 100. The method 200 comprises the following steps.

At step 210, a control command is issued from a device, such as device 120, to the IP camera, such as an IP camera 140. A command time is recorded as the time at which the control command was issued. The control command can comprise, for example, one or more of the following: a pan command; a tilt command; a zoom command; an aperture command; an exposure command; and a focus command. The IP camera executes the control command and performs a corresponding action, for example, a pan, a tilt, a zoom, an opening or closing of the aperture, an exposure adjustment, and/or a focus adjustment.

At step 220, while a streaming video is being received at the device from the IP camera, a change is detected in the streaming video in one or more pixels in associated video frames as a result of the control command being executed by the IP camera. A feedback time is recorded as the time at which the change in the one or more pixels in the video frames was detected at the device. In some embodiments, the change is detected by determining one or more of a directionality and a magnitude of one or more motion vectors in the streaming video to detect, for example, a pan, a tilt or a zoom. Further, a global change in luminance values in the streaming video can be used to detect, for example, an opening or closing of a camera aperture or an exposure adjustment.

In some embodiments, a capture time is also recorded as a time at which the change in one or more pixels in the video frames was captured by an IP camera. The capture time is, for example, determined at the device from a real-time clock signal embedded in the frames of the streaming video, where the real-time clock in each respective frame of the streaming video corresponds to the time at which the respective frame was captured.

At step 230, one or more delays associated with the IP camera are determined by recording and comparing two or more of the following: the command time, the capture time, and the feedback time.

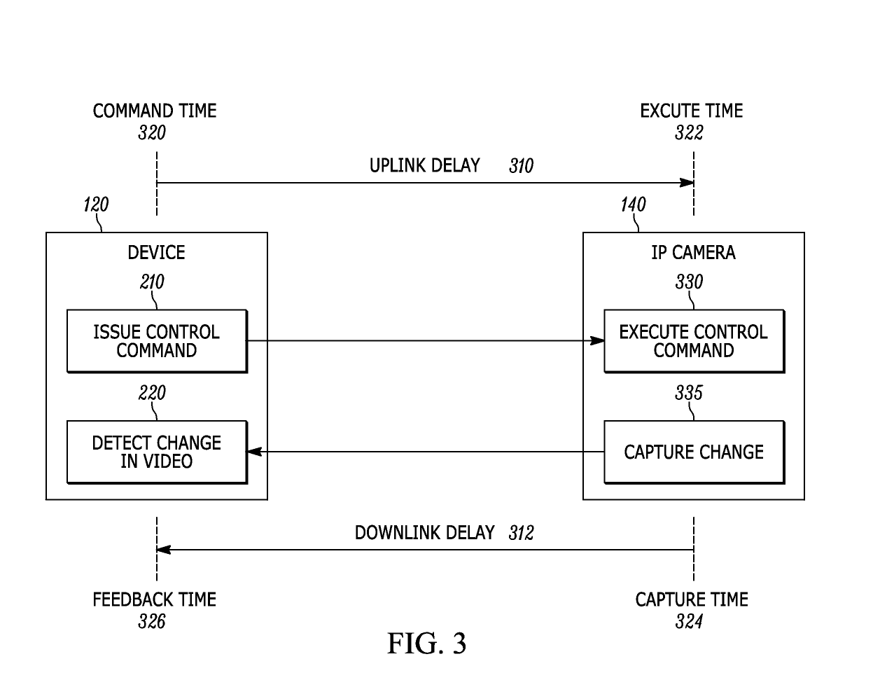

FIG. 3 is a schematic illustrating one or more delays in accordance with some embodiments. An uplink delay 310 and a downlink delay 312 are shown. However, other delays such as a feedback delay and/or a processing delay can be determined

The uplink delay 310 is a difference between the execution time 322 and the command time 320. However, a skilled addressee will appreciate that a negligible delay will occur between a change in the IP camera 140 due to the execution of the control command at step 330 and the capture of the change by the IP camera 140 at step 335. Therefore, the uplink delay 310 can be considered to be a difference between the capture time 324 and the command time 320. The downlink delay 312 is a difference between the feedback time 326 and the capture time 324.

The feedback delay (not shown) is a difference between the feedback time 326 and the command time 320. In some embodiments, an Internet Control Message Protocol (ICMP) “ping” request is transmitted from the device to the IP camera 140. A processing delay is determined as a difference between the feedback delay and a ping response time of the ping request.

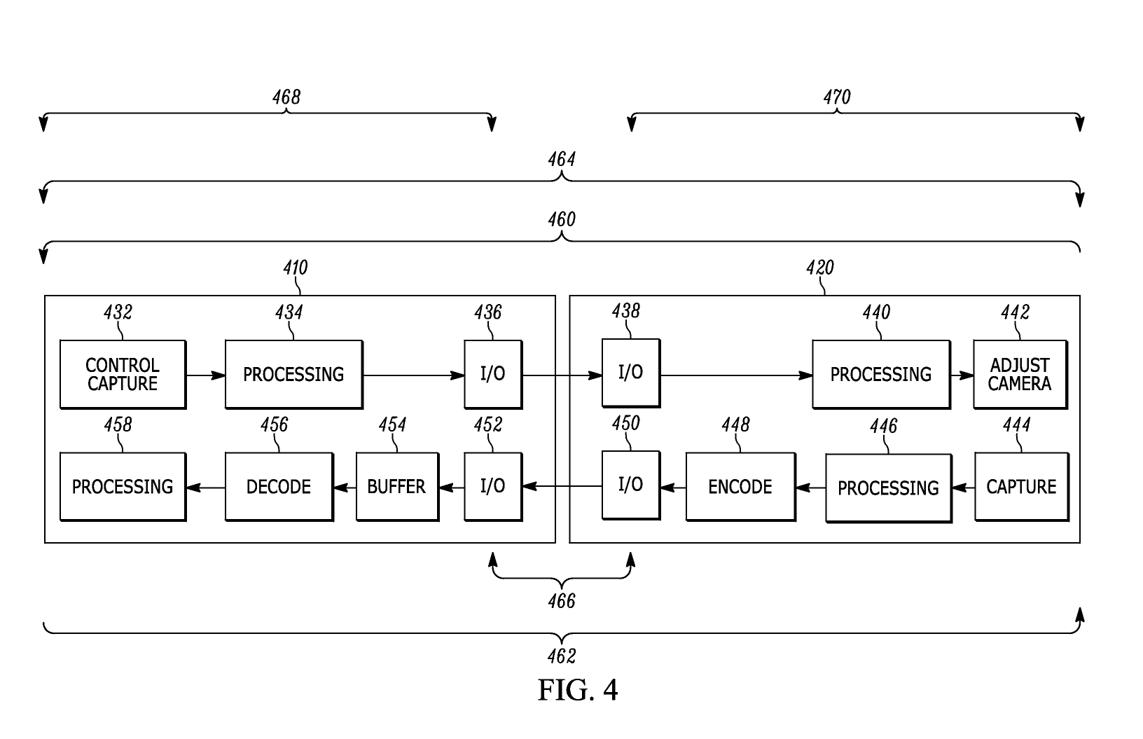

FIG. 4 is a schematic illustrating processing in a device 410 and an IP camera 420, including illustrating one or more delays in accordance with some embodiments. For example, the device 410 can be identical to the device 120 and the IP camera 420 can be identical to the IP camera 140.

The control command is captured by the device 420 at step 432. For example, the control command is input into the device 420 or selected via an interface of the device 420. The control command is then processed by the device 410 at step 434 and transmitted via an input/output of the device 410, such as a communications device, to the IP camera 420 at step 436.

At step 438, the control command is received at an input/output of the IP camera 420, such as a communications device of the IP camera 420. The control command is then processed by the IP camera 420 at step 440, and executed to adjust the IP camera 420 at step 442. For example, execution can comprise the control command being issued to a pan/tilt/zoom motor of the IP camera 420 to pan, tilt and/or zoom the IP camera 420.

At step 444, the IP camera 420 captures a streaming video. Video frames of the streaming video will show a change in their pixels due to the control command being executed. For example, a movement of pixels in the video frames can occur due to a pan or tilt command being executed.

At step 446, the IP camera 420 processes the video frames of the streaming video as each video frame is captured. At step 448 the IP camera 420 then encodes the video frames of the streaming video, and at step 450 transmits the frames of the streaming video via the input/output of the IP camera 420 to the device 410.

At step 452, the device 410 receives streaming video via an input/output of the device 410 and buffers the streaming video in a buffer at step 454. The device then decodes the streaming video from the buffer at step 456 and processes the streaming video at step 458 for display by the device 410.

The one or more delays illustrated in FIG. 4 include an uplink delay 460, a downlink delay 462, a feedback delay 464, a ping response time 466, a device processing delay 468 and an IP camera processing delay 470. The uplink delay 460 is the time between the capture of the command at step 432 and the adjustment of the IP camera at step 442. The downlink delay 462 is the time between the capture of the video frames and the display of the video after processing at step 458. The feedback delay is the time between the capture of the command at step 432 and the display of the video after processing at step 458.

The device processing delay 468 is the sum of the delays for the processing at steps 434 and 458, the buffering at step 454 and the decoding at step 456. The IP camera processing delay 470 is the sum of the delays for the processing at steps 440 and 446 and encoding at step 448. The ping response time 466 is a sum of the uplink and downlink network delays between the device 410 and the IP camera 420. Because the ping response time does not include the processing delay, the processing delay, which is the sum of the device processing delay 468 and the IP camera processing delay 470, can be determined as the difference between the feedback time 464 and the ping response time 466.

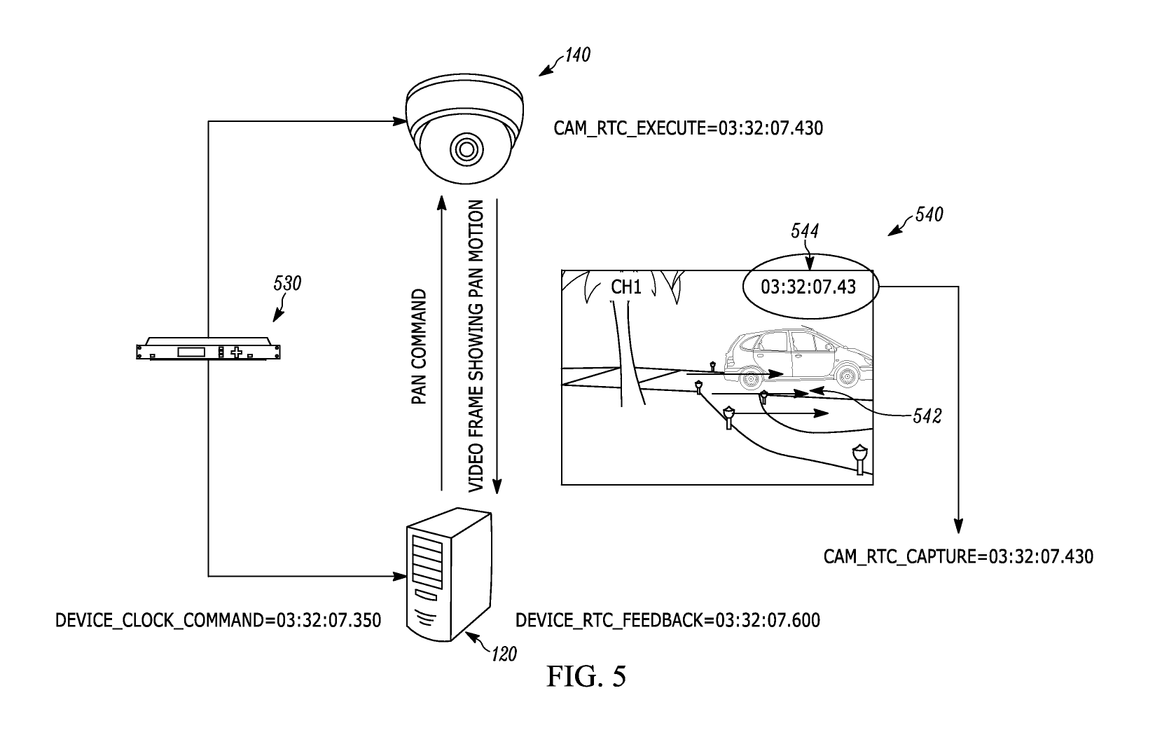

FIG. 5 is a schematic showing an example determination of one or more latency times in accordance with some embodiments. A real-time clock 544 is provided in each respective frame of a streaming video. The real-time clock 544 corresponds to the time at which the respective frame was captured. In some embodiments, a request to include the real-time clock 544 in the frames of the streaming video is transmitted from the device 120 to the IP camera 140. The IP camera 140 receives the request and configures the IP camera 140 to include the real-time clock 544 in the frames of the streaming video.

The real-time clock 544 is synchronized with a clock of the device 120. For example, FIG. 5 shows a time server 530, such as a Network Time Protocol (NTP) server in communication with the IP camera 140 and the device 120. The clock of the device 120 is synchronized with the time server 530 and a request is transmitted from the device 120 to the IP camera 140 to synchronize the real-time clock 544 with the time server 530.

In the example shown in FIG. 5, a pan command is transmitted from the device 120 to the IP camera 140. A command time (e.g., DEVICE_CLOCK_COMMAND) is recorded from the clock of the device 120 to be “03:32:07.350”. The pan command is executed at the IP camera 140 at an execute time (e.g., CAM_RTC_EXECUTE) which is “03:32:07.430”. Video frames, including video frames showing the pan motion, are transmitted from the IP camera 140 to the device 120, and a change in the video frames associated with the pan command is detected at the device 120. A feedback time (DEVICE_RTC_FEEDBACK) is recorded from the clock of the device 120 to be “03:32:07.600”.

The change in the video frames associated with the pan command is detected by determining one or more of a directionality and a magnitude of one or more motion vectors in the streaming video.

In some embodiments, the device 120 takes advantage of the motion vector information already present in the encoded video stream. However, for example, if the device does not have access to the motion vector data, the device 120 can alternatively run a motion estimation algorithm on the decoded video.

The device 120 then waits for a video frame where the majority of macroblocks show relatively uniform movement in the same direction as the issued pan command, as shown in video frame 540. The device 120 determines the feedback time as the time of the clock of the device 120 when movement is first detected in the above direction.

The device 120 records the last decoded real-time clock value from the streaming video as the capture time, which corresponds to the real-time clock of the IP camera immediately after executing the pan command.

In some embodiments, motion vectors in the streaming video are used to determine an appropriate control command For example, an average direction of motion in the streaming video is determined and the control command is selected such that the IP camera moves in a direction that is orthogonal to the average direction of motion. For example, if object movement is generally left-to-right, the control command may be to pan right-to-left. In another example, if the object movement is generally left-to-right or right-to-left, the control command may be a tilt (up-to-down or down-to-up operation). In another example, if the object movement cannot be generalized, the command control may be a non-motion directive, such as a zoom or aperture control operation. This can improve detection of the change in the video frames associated with the camera movement when the scene being viewed by the IP camera 140 includes uniform motion that is not associated with a control command, such as, for example, traffic on a road.

In some embodiments, the real-time clock is overlaid on the frames of the streaming video as shown in video frame 540. The real-time clock is read, for example, via optical character recognition to determine a capture time (e.g., CAM_RTC_CAPTURE) which is “03:32:07.430”.

The feedback delay is the difference between the feedback time and the command time, e.g., 03:32:07.600-03:32:07.350=250 ms (milliseconds).

The execute time and the capture time are the same, because both correspond to the movement of the camera. The uplink delay is therefore the difference between the capture time and the command time, e.g., 03:32:07.430-03:32:07.350=80 ms.

The downlink delay is the difference between the feedback time and the capture time, e.g., 03:32:07.600-03:32:07.430=170 ms.

In alternative embodiments, where the control command is an opening or closing of the aperture or an exposure adjustment, the device 120 waits for a video frame where all the pixels in the luminance channel (Y) begin to show uniform change in magnitude in accordance with the issued command.

In some embodiments, the device 120 can derive a more accurate time than is provided by the real-time clock of the IP camera 140. For example, if the real-time clock provides a resolution to only seconds, the device can derive a more accurate measurement. To do so the device 120 first determines the frame rate of the IP camera 140. For example, the number of unique video frames per second received at the device 120 from the IP camera can be counted to determine the frame rate of the IP camera 140.

The device 120 then waits for a video frame in which the seconds value in the overlaid clock is incremented. The device 120 then counts the number of subsequent frames. For example, each frame counted is (1000 /framerate) milliseconds beyond the frame when the seconds count incremented. This procedure enables the device 120 to determine the real-time clock value for any video frame within 1000/framerate. For example, if the framerate is 30 frames per second, the real-time clock can be determined to within 33 milliseconds.

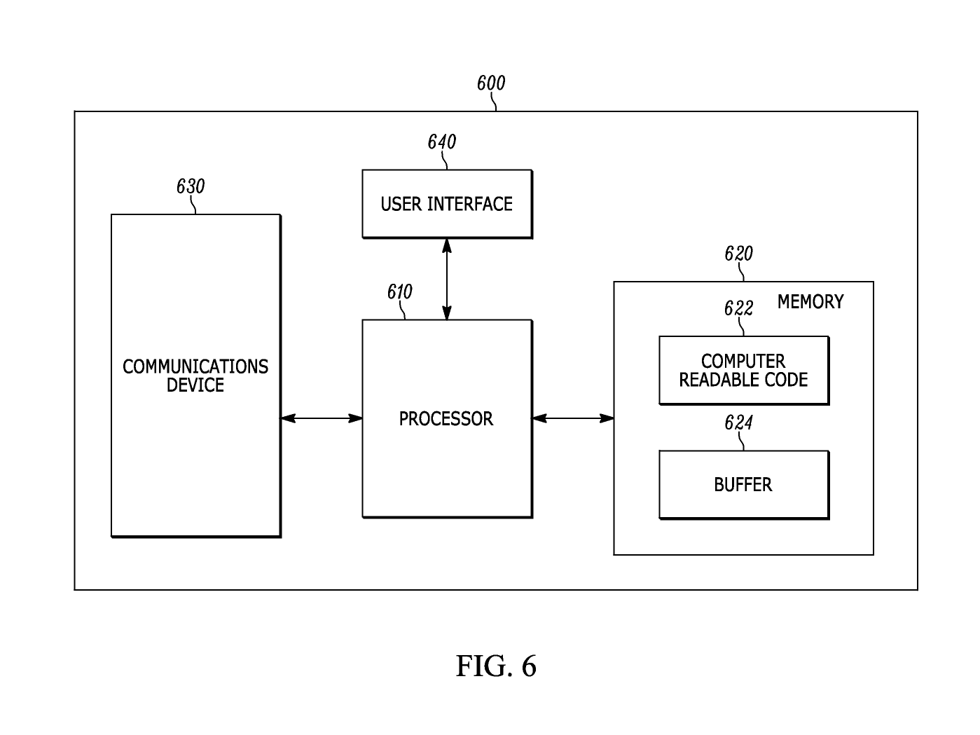

FIG. 6 is a schematic of a device 600 for determining one or more delays associated with an IP camera in accordance with some embodiments. For example, the device 600 can be identical to the device 120 or to the device 410 referred to above, and the IP camera can be identical to the IP camera 140 or to the IP camera 420 referred to above.

In some embodiments, the device is a remote terminal that is remote from the IP camera. For example, the remote terminal can also be used to monitor the streaming video from the IP camera and control the IP camera for surveillance.

The device 600 comprises a processor 610 and a memory 620 coupled to the processor 610. A communications device 630 is coupled to the processor 610. The communications device 630 is in communication with the IP camera.

The memory 620 comprises instruction code 622 for: issuing from the device 600, a control command to the IP camera; detecting, in a streaming video being received at the device 600 from the IP camera, a change in one or more pixels in the video frames as a result of the control command being executed by the IP camera; and determining one or more delays associated with the IP camera by recording and comparing two or more of a command time, a feedback time and a capture time.

The processor 610 processes the instruction code stored in the memory 620 and implements various methods and functions of the device, as described herein.

The memory 620 can include a buffer 624 to assist in processing streaming video from the camera and implementing the claimed invention. The buffer 624 stores video frames of the streaming video as they are received. As will be understood by a person skilled in the art, a single memory, such as the memory 620, can be used to store both dynamic and static data.

The structure of the memory 620 is well known to those skilled in the art and can include a basic input/output system (BIOS) stored in a read only memory (ROM) and one or more program modules such as operating systems, application programs and program data stored in random access memory (RAM).

One or more interfaces 640 are coupled to the processor 610, for example, to enable a user to view the streaming video and/or input or select a control command.

The one or more interfaces 640 can include, for example, one or more output devices, such as a monitor or touchscreen, and/or one or more input devices, such as a keyboard, a mouse, a trackpad, a touchscreen, or another controller which enables a user to issue a control command.

In some embodiments, the memory 620 comprises instruction code for performing one or more of the steps of the method 200. The memory 620 can also include instruction code for performing other actions at the device as described herein.

In some embodiments, the memory 620 comprises instruction code for detecting ‘static’ motion of a scene prior to issuing a control command. Where the scene exhibits little uniform motion, any controlled pan or tilt will generally be relatively easy to detect. However, where the scene exhibits a lot of static motion on one plane, for example, left-to-right traffic at a traffic intersection, the instruction code can select a control command that manipulates the IP camera in an opposing plane, for example the instruction code can issue a tilt command to the IP camera. If the instruction code is unable to definitively detect uniform controlled motion, the instruction code can temporarily reposition the camera to a different field-of-vision where there is little to no static motion.

In some embodiments, the memory 620 comprises instruction code for implementing the methods described herein on a plurality of IP cameras, for example, in a surveillance network.

In some embodiments, a time of the clock of the device is recorded both when a packet arrives at the device, for example, using a packet capture (PCAP) interface, as well as when the buffering/decoding/processing is complete. This enables the device processing delay to be determined Determination of the device processing delay can assist in defining a minimum bound on the feedback delay, and enable the IP camera processing delay to be determined, for example, as the difference between the processing delay and the device processing delay.

One benefit of some embodiments of the present invention is that one or more delays, including one-way latencies and processing delays, can be determined from a single remote device. These delays can be automatically measured on a plurality of IP cameras without disabling each camera's operation or physically adapting the IP camera. Indeed, the one or more delays can be determined as part of the normal operation of the IP cameras.

Measurement of such delays can detect problems that would result in jitters and visible artifacts in the display of the streaming video from the IP camera. The delays can also reflect the responsiveness of control commands As such, the one or more delays can provide an objective means to categorize a deployed IP camera as “acceptable”, and can enable a proactive service response well before a customer may notice a deficiency.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of determining one or more delays associated with an internet protocol (IP) camera, the method comprising:
issuing from a device, a control command to the IP camera;
detecting, in a streaming video being received at the device from the IP camera, a change in one or more pixels in the video frames as a result of the control command being executed by the IP camera; and
determining one or more delays associated with the IP camera by recording and comparing two or more of the following:
a command time being a time at which the control command was issued from the device;
a capture time being a time at which the change in one or more pixels in the video frames as a result of the control command being executed by the IP camera was captured by the IP camera; and.
a feedback time being a time at which the change in one or more pixels in the video frames as a result of the control command being executed by the IP camera was detected at the device.

2. The method of claim 1, wherein the IP camera is a surveillance video camera.

3. The method of claim 1, wherein the control command comprises one or more of the following:
a pan command;
a tilt command;
a zoom command;
an aperture command;
an exposure command; and
a focus command.

4. The method of claim 1, wherein detecting a change in one or more pixels in the video frames as a result of the control command being executed by the IP camera comprises determining one or more of the following:
one or more of a directionality and a magnitude of one or more motion vectors in the streaming video; and
a global change in luminance values in the streaming video.

5. The method of claim 1, further comprising:
determining an average direction of motion in the streaming video; and
selecting the control command such that the IP camera moves in a direction that is orthogonal to the average direction of motion.

6. The method of claim 1, further comprising:
determining an average direction of motion in the streaming video; and
selecting the control command to be a non-motion directive.

7. The method of claim 1, wherein determining one or more delays associated with the IP camera comprises determining one or more of the following:
a feedback delay being a difference between the feedback time and the command time;
an uplink delay being a difference between the capture time and the command time; and
a downlink delay being a difference between the feedback time and the capture time.

8. The method of claim 1, further comprising:
determining the capture time at the device from a real-time clock in the frames of the streaming video, the real-time clock in each respective frame of the streaming video corresponding to the time at which the respective frame was captured.

9. The method of claim 8, wherein a request to include the real-time clock in the frames of the streaming video is transmitted from the device to the IP camera.

10. The method of claim 8, further comprising:
synchronizing a clock of the device with a time server, wherein one or more of the command time and the feedback time are determined from the clock of the device; and
transmitting from the device to the IP camera, a request to synchronize the real-time clock with the time server.

11. The method of claim 8, wherein the real-time clock is overlaid on the frames of the streaming video and the method comprises:
reading the real-time clock via optical character recognition to determine the capture time.

12. A device for determining one or more delays associated with an internet protocol (IP) camera, the device comprising:
a processor;
a communications device coupled to the processor, the communications device in communication with an IP camera; and
a memory coupled to the processor, the memory comprising instruction code for:
issuing from a device, a control command to the IP camera;
detecting, in a streaming video being received at the device from the IP camera, a change in one or more pixels in the video frames as a result of the control command being executed by the IP camera; and
determining one or more delays associated with the IP camera by recording and comparing two or more of the following:
a command time being a time at which the control command was issued from the device;
a feedback time being a time at which the change in one or more pixels in the video frames as a result of the control command being executed by the IP camera was detected at the device; and
a capture time being a time at which the change in one or more pixels in the video frames as a result of the control command being executed by the IP camera was captured by the IP camera.

13. The device of claim 12, wherein the device is a remote terminal that is remote from the IP camera.

14. The device of claim 12, wherein the control command comprises one or more of the following:
a pan command;
a tilt command;
a zoom command;
an aperture command;
an exposure command; and
a focus command.

15. The device of claim 12, wherein the instruction code for detecting a change of the IP camera associated with the control command comprises instruction code for determining one or more of the following:
one or more of a directionality and a magnitude of one or more motion vectors in the streaming video; and
a global change in luminance values in the streaming video.

16. The device of claim 12, further comprising instruction code for:
determining an average direction of motion in the streaming video; and
selecting the control command such that the IP camera moves in a direction that is orthogonal to the average direction of motion.

17. The device of claim 12, further comprising instruction code for:
determining an average direction of motion in the streaming video; and
selecting the control command to be a non-motion directive.

18. The device of claim 12, wherein the instruction code for determining one or more delays associated with the IP camera comprises instruction code for determining one or more of the following:
a feedback delay being a difference between the feedback time and the command time;
an uplink delay being a difference between the capture time and the command time; and
a downlink delay being a difference between the feedback time and the capture time.

19. The device of claim 12, further comprising instruction code for:
determining the capture time at the device from a real-time clock in the frames of the streaming video, the real-time clock in each respective frame of the streaming video corresponding to the time at which the respective frame was captured.

20. The device of claim 19, further comprising instruction code for:
transmitting a request to include the real-time clock in the streaming video from the device to the IP camera.

21. The device of claim 19, further comprising instruction code for:
synchronizing a clock of the device with a time server, wherein one or more of the command time and the feedback time are determined from the clock of the device; and
transmitting from the device to the IP camera, a request to synchronize the real-time clock with the time server.

22. The device of claim 19, wherein the real-time clock is overlaid on the frames of the streaming video and the device further comprises instruction code for:
reading the real-time clock via optical character recognition to determine the capture time.
